(19) United States
(12) Patent Application Publication
(10) Pub. No.: US 2005/0067111 A1
(43) Pub. Date: Mar. 31, 2005

(54) System and associated method for high output label application

(75) Inventor: John William Geurtsen, Holliston, MA (US)

Correspondence Address: WOOD, HERRON & EVANS, LLP, 2700 CAREW TOWER, 441 VINE STREET, CINCINNATI, OH, 45202, US

(73) Assignee: MCC-Dec Tech, L.L.C., Cincinnati, OH (US)

(21) Appl. No.: 10/675,421

(22) Filed: Sep. 30, 2003

(51) Int. Cl. B32B 31/00

(52) U.S. Cl. 156/556; 156/566; 156/567

(57) ABSTRACT

A system used for applying labels, such as heat-transfer labels, to articles, includes an article conveyor adapted for intermittent motion. The system also includes a plurality of decorating stations located proximate to the article conveyor. Each of the plurality of decorating stations includes a transfer roll. Each one of the plurality of transfer rolls is associated with one of a plurality of webs. These webs carry labels, such as heat-transfer labels, to be applied from the transfer rolls to articles being carried along the article conveyor during operation of the apparatus. The intermittent motion of the conveyor includes a moving period and a stopping period. The stopping period of the intermittent motion substantially coincides with the application of the labels to the articles

### FIELD OF THE INVENTION

The present invention relates generally to a system and associated method for applying decoration to articles, and particularly to a system and associated method used to apply labels to containers and other articles which require decoration.

### BACKGROUND OF THE INVENTION

Labels, such as heat-transfer labels, are commonly used in the decorating and/or labeling of commercial articles, such as containers for beverages, oils, detergents, chemicals, and health and beauty aids. Heat-transfer labels are desirably resistant to abrasion and chemical effects in order to avoid loss of label information, and heat-transfer labels desirably possess good adhesion to the articles to which they are affixed. Application of heat-transfer labels to articles to which they are affixed occurs in machinery in which the adhesive labels are associated with a carrier web which passes along and in contact with articles which require decoration. As the web including labels passes along and in contact with the articles, the label is released from the web and adheres to the articles.

The technology for transferring labels, such as heat transfer labels, from a moving carrier web to articles which require decoration includes various machines and systems. These machines and systems generally fall into one of two categories: (1) “intermittent” machines or systems, and (2) “continuous-motion” machines or systems.

In intermittent machines, the equipment is generally designed so that the web having labels associated therewith passes across a transfer roll of a decorating station in proximity to an article conveyor. The article conveyor carries articles to be labeled along a labeling path and stops an article in front of and in confronting relationship with the transfer roll. The article is then rotated against the label and web, which is drawn across the transfer roll. The web is drawn at a velocity so that the web speed and the surface velocity of the article are substantially equal. Because the web carries the adhesively active labels, the label is essentially released from the web and applied to the article as they move against one another. Once a label has been applied, the article conveyor moves the labeled article away from and out of confronting relationship with the transfer roll and moves the next unlabeled article into position in front of and in confronting relationship with the transfer roll, and stops the article in that position, where the labeling process is repeated.

More specifically, to decorate a cylindrical article, the article must rotate directly in front of and in contact with the label and web associated with a transfer roll to apply a label. This creates the need to stop the article after indexing the article into a position proximal to the transfer roll, in order to achieve the proper application. As described above, this is along the article conveyor proximal to and in confronting relationship with the web associated with the transfer roll. After the article has stopped and is in confronting relationship with the label and web at the transfer roll of a decorating station, an article-holding assembly may be used to rotate the article against the label/web and transfer roll. The article holding assembly may include a rotatable cup, in which the article may be seated, and a nozzle which confronts and attaches to the top of the article as it is seated in the rotatable cup. As the cup rotates, the article seated therein rotates cooperatively. The nozzle may be used to inject air into the article during the label application process, and particularly prior to rotating the article and applying the label. Since the label is positioned between the article and the transfer roll, with movement of the label driven by motion of the web being drawn across the transfer roll, the label is applied to the article during rotation of the rotatable cup. Generally, only one article holding assembly is located at the position where label application occurs.

There are several drawbacks to the intermittent machine for label application described above. For example, the standard output for typical intermittent machines may be generally about 40-70 articles per minute, depending upon the diameter and shape of the article. This rate, in previously used systems, has been accomplished with only one decorating station associated with a system used to apply labels to articles. Enhancements to the drive systems of these machines have increased the speed of this intermittently decorating station to as high as 120-150 articles per minute. However, this rate is still too low an output to allow in-line decorating with high speed container molding operations and/or high speed filling lines, which can operate at rates of a few hundred to several hundred articles per minute. Thus, the slow speed of the intermittent machines may result in a backlog of articles waiting to be labeled. Alternatively, the slow speed may result in the operation of container molding and/or container filling lines at a rate of output lower than their capabilities, thus decreasing productivity of the lines. Still alternatively, such low output results in the need to acquire multiple machines, each including an article conveyor, and employ multiple operators in order to generate a satisfactory output. This results in additional costs for the extra machines and operators, and additional costs associated with article handling/conveying apparatus used to route articles to each machine.

Although the technology for intermittent machines and systems is and has been the subject of developmental effort over many years, the machines have reached a point where further increases in the speed at which the machines are able to label articles may no longer be functionally and/or economically practical. Attempts to operate these intermittent machines at higher decorating speeds than 120-150 articles per minute have resulted in either unacceptable increases in costs due to procurement of multiple machines, each including an article conveyor, and operators, maintenance difficulties with the machines, or unacceptably low quality results of the labeling process.

One reason for the unacceptable low quality of results of the labeling process in some of these higher speed intermittent machines is due to the variables which are necessary to achieve proper transfer of labels. These variables include (1) temperature, (2) pressure, and (3) time. Increased temperature is used to activate the label adhesive as well as to facilitate label release from the carrier web. Pressure is necessary to force the heated label onto the article being decorated. Sufficient time is necessary to properly adhere the label to the article during the application. If any one of these three components is insufficient in a labeling operation, the label may not release from the web properly and/or may not properly or completely become adhered to the article. Thus, although temperature and pressure may be adequate in an intermittent machine, if one were to continue to increase the speed of the rotation of the article and the transfer roll, one would necessarily decrease the time component for adhering the label to the article. This may result in a poor quality bond of label to the article.

In order to increase the output of articles from decorating machines, various high-speed decorating machines for articles which include “continuous” motion have been developed. These decorating machines employ concepts to move the transfer roll with a continuously moving article to allow sufficient time to apply the label as the web moves past the rotating article. These continuous motion machines have achieved speeds of over 400 articles per minute. The increase in the output is due to the fact that, unlike the intermittent machines, no time is lost in stopping the article conveyor during the application of the label. However, as described above, the designs of these machines require the transfer head to partially follow the motion of the article being decorated in order to increase output. This requires an increased number of complex and moving parts over those found in intermittent machines. Additionally, these machines require an article-holding assembly dedicated to each position for an article along the labeling path, whereas the intermittent machines only require one article holding assembly proximal to the decorating station. This again increases the number of parts in the continuous motion machines. Thus, these high-speed continuous motion machines are complex to operate and costly to procure. There is also a resultant increase in the amount of breakdowns experienced by the machine, which results in costly repairs. Such breakdowns also result in backlogs of articles to be labeled due to the downtime of the machine. All of these drawbacks have negatively impacted the cost of using heat-transfer label technology and has thus greatly limited the use of these decorators in the packaging industry.

Another drawback which may be found in both intermittent and continuous motion machines currently in use is the large amount of downtime of the equipment which results during changeover from one type of article to another, or changeover time necessary to switch between application of one type of label, such as a body label, versus the application of a secondary type of label, such as a neck label. Also, downtime may occur when two different labels (i.e., having different text) may be needed to be applied to articles, but the machine can only accommodate one label at a time. Further, downtime may also be increased by a malfunction in the decorating heads, particularly in intermittent machines, requiring the single head to be shut down, thus requiring downtime for the entire machine.

It would therefore be desirable for a decorating system to provide an article-decorating machine capable of operating at substantially higher output speeds than is practical in existing intermittent machinery. It is further desirable that such a machine would provide output which is comparable to the output of continuous motion machines without incurring the cost and other drawbacks of high output continuous motion machines. It would further be desirable to provide a decorator system which is capable of handling a large variety of article shapes and/or types of labels with minimal alteration of the equipment and with minimal downtime of the equipment during changeover from one article to another or one label to another.

With these features in mind, as will be apparent to those skilled in the art, the present invention provides a decorating machine having these desired characteristics, as is described below in the specification and is covered by the claims attached thereto.

### SUMMARY OF THE INVENTION

The present invention overcomes the drawbacks described above in article-decorating and labeling equipment by replacing the conventional single-transfer point intermittent machine with a system having intermittent motion and having a plurality of decorating stations, each including transfer rolls, thus increasing the output of the article-decorating machinery. The output of the system of the present invention may thus be comparable to that of continuous motion machines. By increasing the number of decorating stations, one may generate an output greater than that of present intermittent machines, and as great as or greater than present continuous motion machines. In addition to increasing output, the system of the present invention does so at lower cost than continuous motion machines, due to the lower number of parts and reduced complexity of parts as compared to continuous motion machines.

The system of the present invention, which may be used for applying labels, such as heat-transfer labels, to articles, includes an article conveyor adapted for intermittent motion. The system also includes a plurality of decorating stations located at various intervals about or along the article conveyor. Each of the plurality of decorating stations includes a transfer roll which is located proximal to the article conveyor. In operation, each one of the plurality of transfer rolls is associated with one of a plurality of webs. Each web carries labels, such as heat-transfer labels, to be applied to articles being carried along the article conveyor during operation of the system. The intermittent motion of the system includes a moving period and a stopping period. The stopping period of the intermittent motion substantially coincides with the application of the labels to the articles in the system of the present invention.

Thus the single-transfer roll of previous intermittent machines is replaced by a plurality of decorating stations and transfer rolls operating intermittently, at least a plurality of which are being used at any given time to participate in the labeling process. By use of this system, there is more than one article being decorated at any given moment. This multiplies, by a factor of each operating decorating station, the output of the system of the present invention over that of a single transfer roll intermittent machine.

Thus, the present invention involves maintaining the “intermittent” motion concept, as employed with some existing labeling apparatus, while allowing sufficient time to transfer the labels during the stopping period of the intermittent machine cycle. The system of the present invention may double, triple, quadruple, etc., the output of the system by decorating multiple articles simultaneously during each indexing cycle. Therefore, if at every indexing cycle, the system is able to apply labels to two or more articles at the same time, the resultant output will be a function of the indexing speed (cycles per minute), multiplied by the number of decorating stations applying the labels.

The present invention also provides a method for applying labels, such as heat-transfer labels, to articles. This method of the invention includes use of the system, as described above, comprising an article conveyor having intermittent motion, a plurality of decorating stations, and a plurality of transfer rolls. In the method of the present invention, there are at least first and second transfer rolls associated with the system. A plurality of articles to be labeled are moved along the article conveyor into proximity with the decorating stations. More specifically, the plurality of articles may be further divided into subsets of articles, with each subset containing at least a first container and a second container. These subsets of articles are indexed along a labeling path by the article conveyor. As described above, the decorating stations are situated along and about the article conveyor such that when the intermittent system of the present invention reaches its stopping period, the first decorating station will be aligned with a first container of a subset of articles, and the second decorating station will be aligned with a second container of a subset of articles. These articles may be from the same subset or different subsets of articles. During the stopping period, the articles are rotated relative to the progression of webs associated with the transfer rolls of each of the decorating stations such that a label on each of the webs is released and applied onto each of the first and second articles.

As a result, the system of the present invention involves several advantages over previous article decorating machines. First, the system of the present invention reduces the number of parts needed. For instance, only one article holding assembly need be present for each decorating head, as opposed to one needed for each article location, as in continuous motion machines. Additionally, due to lack of movement of the transfer points, fewer complex moving parts are required in this simple design. Thus, the system of the present invention is also cost competitive versus using multiple slower intermittent machines or high-speed continuous motion transfer machines. As a result, a fewer number of machines are required, and thus only a single operator may be required to oversee the application of labels to the articles. Due to the simple design, there is also a low cost for replacement parts. Additionally, the use of multiple heads may result in the ability to apply separate labels on the same container. For example, one of the decorating stations may apply a label to the body of an article, such as a bottle, whereas a second decorating station may apply a label to the neck of the bottle. Further, the multiple decorating stations allow for alternate decorations for “mixed” pack decorating (involving applying different labels to the similar articles where container A has label A applied and container B has label B applied). Further, the design including multiple heads may reduce downtime of the machine. For example, in the event of a problem with one decorator head, that particular head may be stopped, and maintenance performed on that head while the remaining decorator heads continue to apply labels to articles.

These and other advantages of the application will be apparent to those of skill in the art with reference to the drawings and the detailed description below.

### BRIEF DESCRIPTION OF THE DRAWINGS

While the invention has been disclosed by reference to the details of embodiments of the invention, it is to be understood that the disclosure is intended in an illustrative rather than in a limiting sense, as it is contemplated that modifications will readily occur to those skilled in the art, within the spirit of the invention and the scope of the appended claims.

FIG. 1 is a top view of a system for applying labels to articles in accordance with the principles of the present invention;

FIG. 2 is a perspective view of the system of the present invention depicting the article conveyor, decorating heads, article holding assemblies, carrier webs, and articles in accordance with the principles of the present invention;

FIG. 3 is a top view of an alternate embodiment of the system of the present invention depicting the article conveyor and decorating heads in accordance with the principles of the present invention;

FIG. 4 is a schematic of the progression of the web/label for applying labels to articles of the system in accordance with the principles of the present invention;

FIG. 5 is a perspective view of the article holding assembly in proximity to a transfer roll in accordance with the principles of the present invention;

FIG. 6A is a schematic of an article conveyor of the system of the present invention depicting the articles entering the article conveyor in accordance with the principles of the present invention;

FIG. 6B is a schematic of an article conveyor showing two subsets of articles being registered and indexed into position in the system in accordance with the principles of the present invention; and

FIG. 6C is a schematic of the article conveyor showing a plurality of subsets of articles being registered along a labeling path such that a different article of each subset is placed proximal to each of three decorating stations in accordance with the principles of the present invention.

### DETAILED DESCRIPTION OF THE INVENTION

As described above in the Summary of the Invention, the present invention overcomes the drawbacks of the prior art in article decorating and labeling equipment by replacing the conventional single-transfer point intermittent apparatus with a system 10 having intermittent motion and including a plurality of decorating stations 16 and transfer rolls 18, which increases the output of the labeling machine without having to increase the speeds of drive system(s). This system 10 also increases the output of such labeling machinery while avoiding the multiple parts, expensive cost, increased downtime, etc. exhibited by continuous motion machines.

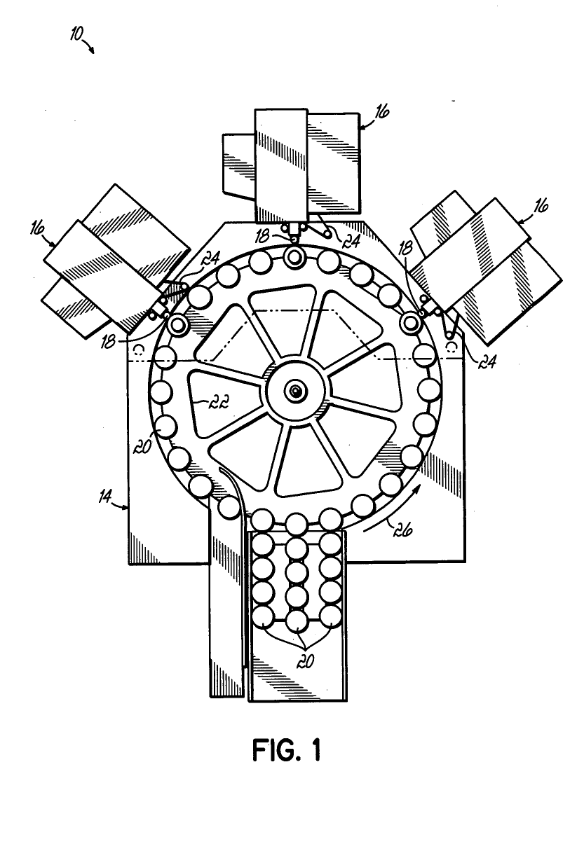

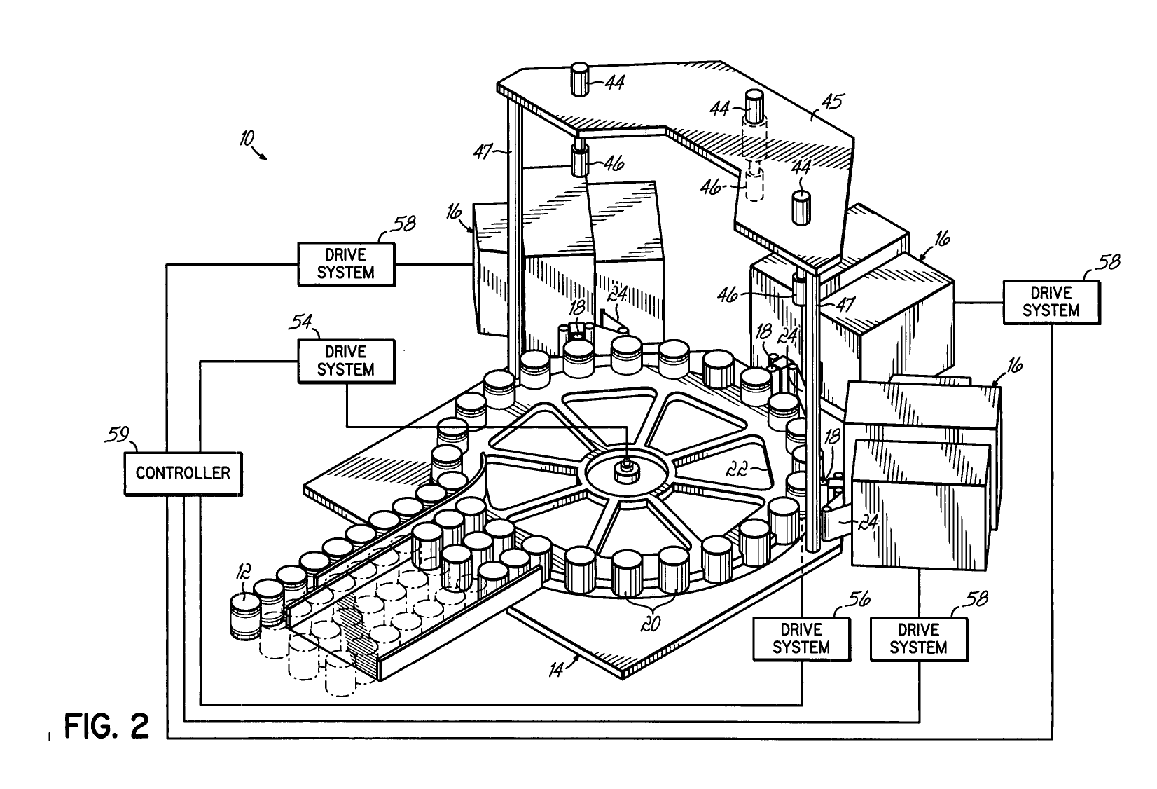

The system 10 of the present invention is used for applying decorations to articles 20. These decorations may include labels 12, and, in particular, may include heat transfer labels 12. However, those of skill in the art will recognize that the apparatus of the present invention may be amenable for use with labels other than heat transfer labels. Referring now to the Figures, and in particular to FIGS. 1 and 2, the system 10 of the present invention includes an article conveyor 14. This article conveyor 14 is movable and is adapted for intermittent motion. The article conveyor 14 is further adapted for carrying articles 20 to be labeled. The intermittent motion of the article conveyor 14 includes a moving period and a stopping period. The stopping period of the intermittent motion substantially coincides with the application of the labels 12 to the articles 20 in the system 10 of the present invention.

The system 10 further includes a plurality of decorating stations 16 which may be located at various intervals about or along the article conveyor 14. Each of the plurality of decorating stations 16 includes a transfer roll 18 which is located proximal to the article conveyor 14. Each transfer roll 18 is adapted to be in confronting relationship with articles 20 being carried by the article conveyor 14. When in this confronting relationship it is not necessary that the transfer roll 18 contact the article 20 due to a carrier web 24 disposed between the transfer roll 18 and article 20. The article conveyor 14 operates to move articles 20 that are to be labeled from a first position distant to a transfer roll 18, to a second position proximal to a transfer roll 18, where the article 20 will be labeled, and thereafter to a third position distant to the transfer roll 18 where the article 20 was labeled. The article 20 is not in confronting relationship with a transfer roll 18 when the article 20 is in the first or third position. The article 20 may be in confronting relationship with a transfer roll 18 when the article 20 is in the second position. In the illustrated embodiment, the article conveyor 14 is depicted as a rotatable turret 22. However, as will be recognized by those of skill in the relevant art, the article conveyor 14 may include other system 10, such as a conveyor belt, or a “pick and place” system 10.

A carrier web 24 is associated with each one of the plurality of transfer rolls 18. These webs 24 carry labels 12 to be applied to the various articles 20 during operation of the system 10. The labels 12 are releasable from the carrier web 24. One particular type of label that may be carried by the webs 24 is a heat transfer label.

Thus, in the system 10 of the present invention, the single-transfer point intermittent apparatus is replaced by a plurality of transfer point intermittent system 10 including a plurality of decorating stations 16, each decorating station 16 having a transfer roll 18. At least a plurality of those decorating stations 16 are being used in the decoration or labeling process during a labeling operation. By the present system 10, there is more than one article 20 being decorated during each stopping period of the intermittent motion. This multiplies by a factor of each operating transfer roll 18, the output of the system 10 of the present invention. For example, in previous single transfer point intermittent machines, the output would be a function of the indexing speed, as measured in cycles per minute, wherein a cycle is described as the number of articles 20 that can be moved through a labeling path 26 by the article conveyor 14 in one minute. Thus, at an indexing speed of 150 cycles/minute, and using one decorating station 16, as in single transfer point machines, the output would be 150 articles labeled per minute. However, if the cycle rate is 150 cycles/minute and there are two operating decorating stations 16, then the output is equal to 300 articles labeled/minute. If the cycle rate is 150 cycles/minute and there are three operating decorating stations 16, then the output is equal to 450 articles labeled/minute. High indexing speeds, such as 150 cycles/minute, can be achieved with any of numerous mechanical and electromechanical drive devices, as will be apparent to those of skill in the relevant art. As described above, the higher the indexing speed the greater the incidence of low quality label placement. Thus the system 10 of the present invention greatly increases output while avoiding the drawback of low quality label application.

While the illustrated embodiment depicts cylindrical containers, it will be recognized that the system 10 of the present invention may be used to decorate several different types of articles 20. For example, the system 10 of the present invention may be used to decorate articles 20 including, but not limited to, tapered round articles, straight-sided articles having oval cross-sections, tapered oval articles, articles having planar sides, and articles having planar sides which are tapered, so that the thickness of the article 20 varies.

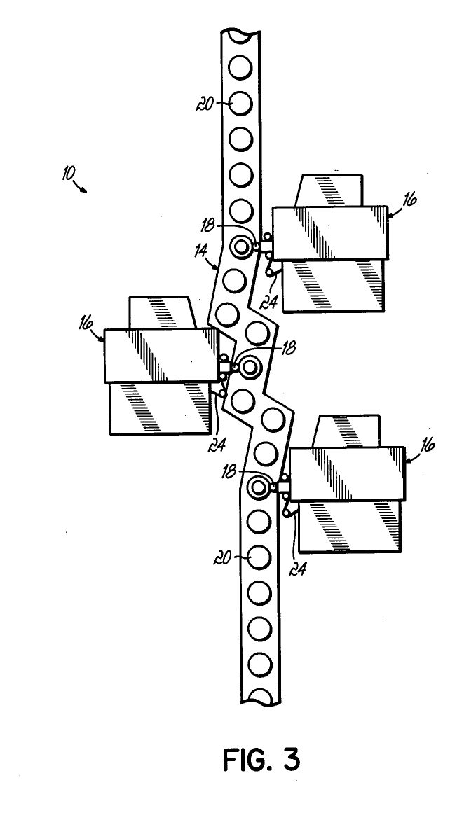

As described above, the article conveyor 14 moves the articles 20 along a labeling path 26. This is the path 26 that articles 20 are moved through by the article conveyor 14 during the labeling process. In the embodiment of the system 10 of the present invention illustrated in FIGS. 1-4, the plurality of transfer heads may be arranged around the outer radius of a rotating turret 22. The labeling path 26 of the invention is thus the circular path taken by the articles 20 as they move through the labeling operation, as illustrated in FIGS. 1-4. However, as will be apparent to those of skill in the art, the labeling path 26 need not be circular, but may take any other shape amenable to the principles of the present invention, such as the labeling path 26 shown in the alternate embodiment of FIG. 3.

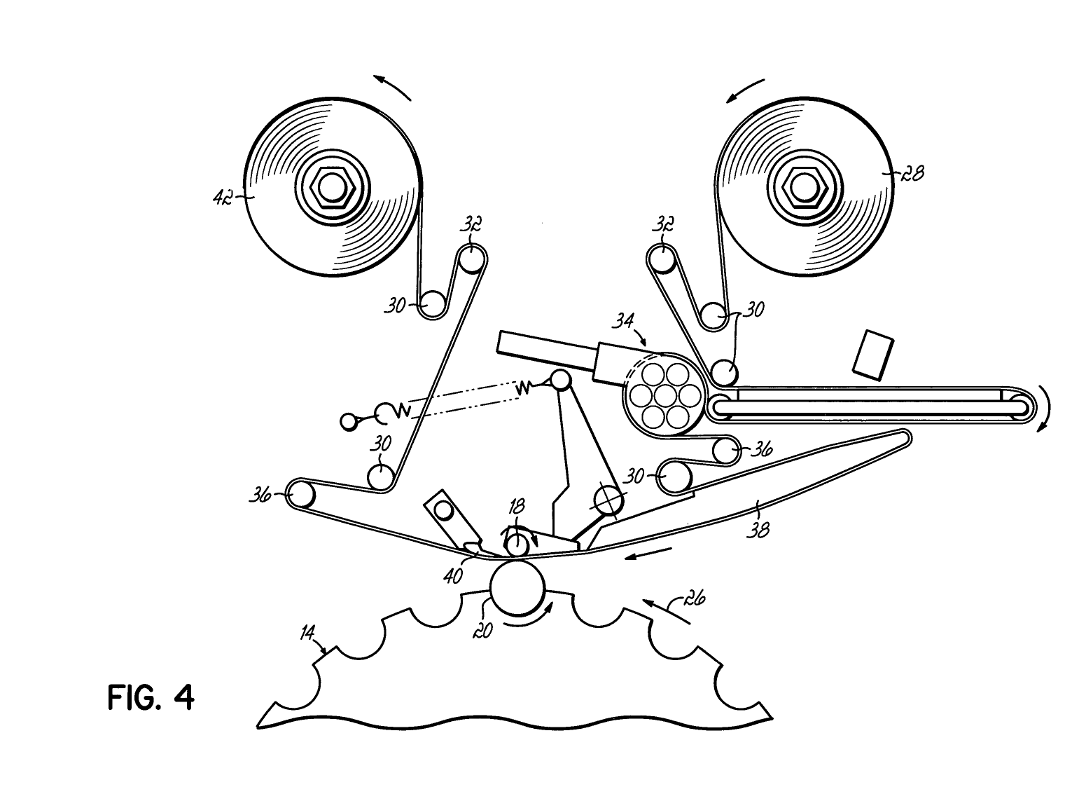

In general, for decorating articles 20 with labels 12, such as heat transfer labels 12, the web 24 with a label 12 associated therewith, may be drawn against a transfer roll 18 and move at a pre-programmed speed and in a pre-programmed direction. Referring now to FIG. 4, the travel of the carrier web 24 and labels 12 of the illustrated embodiment is depicted. The label is releasable from the web 24 and the web 24 progresses from a feed reel 28 to the transfer roll 18. After being taken from the rotating feed reel 28, the web 24 passes through a series of idler rolls 30, dancer rolls 32, metering rolls 34, and shuttle rolls 36 before passing across the transfer roll 18 of the decorator station. Prior to reaching the transfer roll 18, the temperature of the label 12 and web 24 may be increased by moving the web 24 in proximity to a label preheater 38. This increased temperature may serve to facilitate release of the label from the web 24, and further may activate an adhesive on the label to facilitate adherence of the label to the article 20. Each transfer roll 18 contacts the side of the web 24 opposite the label and is rotatable as the web 24 is drawn across the transfer roll 18 and the label 12 contacts an article 20. Each decorating station 16 and/or transfer roll 18 can individually be moved outwardly, in a direction toward the article 20 to be labeled, by means of a fixed cam, or by other means, to confront and press the web 24 and label 12 against the article 20 being labeled at the required time, namely during the stopping period of the intermittent motion of the article conveyor 14. Additionally, as in the illustrated embodiment, the system 10 may include a web guide bar 40, which also assists in facilitating contact between the web 24, labels 12, and the articles 20. When decorated articles having a surface such as a tapered surface either the transfer roll 18 or the article 20, or both, may be positioned at an angle to allow proper labeling.

As depicted in the illustrated embodiment, after the label has been applied to an article 20, the now empty carrier web 24 may progress again through a series of idler, dancer, and shuttle rolls 32, 34, 36 to a take-up reel 42. A series of rolls for progression of the web 24 and labels 12, as described above, may be present for each of the plurality of decorating stations 16 of the system 10. It will be recognized by those skilled in the art that the particular number, type, and configuration of components described above and depicted in FIG. 4 is merely illustrative.

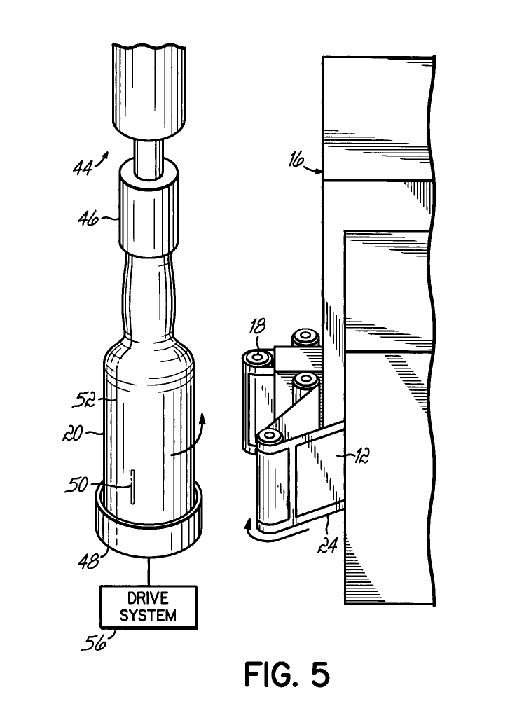

In the illustrated embodiment of the present invention, the system 10 may include an article holding assembly 44 associated with each of the plurality of decorating stations 16. Referring now to FIG. 5, the article holding assembly 44 may include a nozzle 46 disposed above an article 20 and adapted to be in confronting relationship with an article 20 when the article 20 is in confronting relationship with the decorating station 16. At least a portion of the article holding assembly 44, such as the nozzle 46 (in the illustrated embodiment of FIG. 2), may be operatively connected to a panel 45 affixed to support posts 47. The nozzle 46 may be adapted to contact and confront the article 20 in such manner as to inflate the article 20. The nozzle 46 is attached to a conduit, such as a hose, which delivers air, or other gas, into the article 20. In particular, in certain articles 20 it is advantageous to inflate the article 20 with air prior to labeling, and to maintain the inflated state of the article 20 during labeling. If the article 20 is not inflated, the surface of the article 20 to be labeled may collapse under the pressure caused by contact of the web 24 and transfer roll 18 of the decorating station 16 as the web 24 and label 12 contact the article 20 to apply the label 12. As noted above, if there are three decorating stations, as in the illustrated embodiment, there need be only three article holding assemblies 44. This is advantageous over continuous motion machines which include an article holding assembly 44 at each container location along the article conveyor 14, in that it reduces the parts and cost of the system 10 of the present invention.

Still referring to FIG. 5, the article holding assembly 44 may also include an article seat 48 disposed beneath the article 20 when the article 20 is in the article holding assembly 44. This article seat 48 may be adapted to receive the article 20 to be labeled. The article seat 48 may be in the form of cups which are situated along the article conveyor 14 and may be situated in a plane below the surface of the article conveyor 14 with which the articles 20 travel. In the illustrated embodiment, there is one article seat 48 disposed proximal to each decorating station 16, and substantially aligned with the nozzle 46 of each article holding assembly 44.

In one embodiment, the articles 20 move along the article conveyor 14 until they reach the point in front of the transfer head of the decorating station 16. At that point, and coinciding with the stopping period of the article conveyor 14, the article seat 48 may receive the article 20 such that the article 20 is disposed seated in the article 20 seat. The receipt of the article 20 by the article seat 48 may be facilitated by the nozzle 46, described above, descending from above the article 20 to contact and inflate the article 20 with air prior to rotating the article 20 for application of the label. As the nozzle 46 contacts the article 20, the nozzle 46 may force the article 20 into a receiving relationship with the article seat 48. Once the article 20 is seated in an article seat 48 and has a nozzle 46 attached, the article 20 is inflated with air. The article seat 48 of the article holding assembly 44 is then rotated, which cooperatively rotates the article 20 situated therein as the transfer roll 18 with web 24 and label 12 associated therewith is positioned to apply pressure to the article 20 so that the label 12 will be released from the web 24 and applied to the article 20 to be decorated. In an alternate embodiment, there may be one article seat 48 at each location where an article 20 may move along with the article conveyor 14. In such an alternate embodiment, there may be a nozzle 46 at each location where an article 20 may move along with the article conveyor 14. Thus, as the articles 20 move onto the article conveyor 14, they are each disposed into an article seat 48 as they progress along the labeling path 26 to proximity with a decorating station 16.

The article holding assembly 44, as described above, includes article seats 48 with the ability to turn the article 20 to be decorated at the required speed, and may include nozzles 46 for inflating the articles 20. The nozzles 46 may be adjustable both radially and axially. The article seats 48 may be adjustable radially. As a result, the article holding assemblies 44 may be adapted to different sized and shaped articles. The article seats 48 may also have the ability to rotate and register the object being decorated with respect to any known mark, such as a detent 50, which may be located on the bottom, side, or other location of an article, such as a round bottle, where a feature 52 of the article 20 may be required to be avoided for decorating purposes. In the illustrated embodiment, such a feature 52 is depicted as a seam of a bottle. However, it will be apparent to those of skill in the art that articles 20 may include features 52 other than seams, such as an embossed portion of an article 20. Further, the article holding assemblies 44 may be positioned at an angle, in order to shift the article 20 at an angle. This allows for label application to tapered surfaces.

The web 24 and labels 12 are associated with the transfer rolls 18 and move cooperatively with the transfer rolls 18. Thus, the transfer roll 18 and the article seat 48 rotate in opposite directions. During the actual decorating process, the article seat 48, and the article 20 held in it, rotate such that the surface speed of the article 20 matches the web speed, thereby affecting smooth label transfer from the web 24 to the article 20 being decorated.

The system 10 of the present invention also may include first, second, and third drive systems 54, 56, 58. The first drive system 54 is operatively connected to the article conveyor 14 and serves to move the article conveyor 14. The second drive system 56 is operatively connected to the article seat 48 of the article holding assembly 44 and is adapted to rotate the article seat 48. The third drive system 58 is operatively connected to the decorating station 16 and operates to move the web 24 across the transfer roll 18. The system 10 of the present invention further includes a controller 59 operably coupled to the drive system 54 of the article conveyor 14, the drive systems 58 of each of the decorating stations 16, and the drive system 56 of the article seat 48 to coordinate the intermittent motion of the article conveyor 14 with the operation of the decorating stations 16 and rotation of the articles 20 to apply labels to articles 20.

As described above, and as will be appreciated by those of skill in the art, any standard mechanical or electromechanical drive system may be used in the system 10 of the present invention. A common type of drive system is a standard geartrain and motor. For illustrative purposes, the motor generally comprises a stator plate and a rotor mounted for rotation in the stator plate. The geartrain comprises meshing gears, including gear teeth and pinion teeth, positioned in confronting and contacting relationship with one another to drive parts of the system 10 of the present invention, such as the article conveyor 14 and transfer rolls 18. For example, in a geartrain drive system including first and second gears, as the rotor of the motor is driven, the rotor pinion rotates, thereby rotating a first gear to which the rotor pinion is operatively connected. The first stage pinion rotates cooperatively with the first stage gear, and in turn, will rotate a second stage gear to which the first stage pinion is operatively connected. A second stage pinion rotates cooperatively with the second stage gear, and in turn, will rotate a gear which is operatively connected to a portion of the system 10, such as the rotatable turret 22 of the illustrated embodiment, thus causing the turret 22 to rotate in order to move the articles 20 along the labeling path 26. A first drive system 54 may be used to drive the movement of the article conveyor 14. As the path moves articles 20 to be decorated which are originally held in a first position distant to the transfer head, may be moved by the article conveyor 14 along the labeling path 26 to a second position proximal to one of the plurality of transfer rolls 18. As this occurs, the article 20 is seated in or becomes seated in an article holding assembly 44 which holds and may rotate the articles 20 to be labeled.

As described above, the system 10 of the present invention includes a second drive system 56 for rotating the article seat 48 of the article holding assembly 44. This drive system may be a motor and geartrain system as described above, or any other drive system amenable to rotating an article seat 48, as will be recognized by those of skill in the art. Also, as described above, the system 10 of the present invention may further include a third drive system 58 operatively connected to a decorating station 16 to move the web 24 across the transfer roll 18. This drive system may be a motor and geartrain system as described above, or any other drive system amenable to facilitating the progression of the web 24, as will be recognized by those of skill in the art. The second drive system 56 causes the article seat to be rotated in a first direction and the movement of the web 24 by the third drive system 58 causes the transfer roll 18 to be rotated in a second direction, the second direction being opposite to the first direction. The second and third drive systems 56, 58 also rotate such that the surface speed of the article 20 matches the web speed. In this manner, a label 12 may be properly applied to an article 20.

In the intermittent motion of the system 10 of the present invention, a stopping period occurs when articles 20 are associated with and proximal to the plurality of decorating stations 16. During this stopping period, the second and third drive systems 56, 58, as described above, are activated to facilitate the adherence of labels 12 to articles 20. In one embodiment of the present invention, labels 12 are applied to the articles 20 at a rate greater than 150 labels per minute. However, as will be recognized by those of skill in the relevant art, the output rate may be increased by increasing the number of decorating stations 16.

As will be recognized by those of skill in the art, in one embodiment of the present invention, each of the plurality of decorating stations 16 may apply labels 12 to articles 20 during a stopping period. However, in an alternate embodiment of the present invention, only certain ones of the plurality of decorating stations 16 apply labels 12 to articles 20. This may occur when one or more decorating stations 16 are malfunctioning, or undergoing repair, or when the label roll and web 24 are being changed, or simply to slow the output of the system 10.

The present invention also provides a method for applying labels 12, such as heat-transfer labels 12, to articles 20. This method of the invention includes use of the system 10, as described above, comprising an article conveyor 14 having intermittent motion, and a plurality of decorating stations 16, each plurality of decorating stations 16 including a transfer roll 18. In the method of the present invention, there are at least first and second transfer rolls 18 associated with the system 10. A plurality of articles 20 to be labeled are moved along the article conveyor 14 into proximity with the decorating stations 16. More specifically, the plurality of articles 20 may be further divided into subsets 60 of articles 20, with each subset 60 including at least a first article 20 and a second article 20. These subsets 60 of articles 20 are moved along a labeling path 26 by the article conveyor 14. As described above, the decorating stations 16 are situated along and about the article conveyor 14 such that when the intermittent system 10 of the present invention reaches its stopping period, the first transfer roll 18 may be aligned with a first article 20 of a subset 60 of articles 20, and the second transfer roll 18 may be aligned with a second article 20 of a subset 60 of articles 20. These articles 20 may be from the same subset 60 or different subsets 60 of articles 20. During the stopping period, the articles 20 are rotated relative to the progression of webs 24 along each of the transfer rolls 18 of each of the decorating stations 16 such that labels 12 on the web 24 are released and applied onto each of the first and second articles 20, 20.

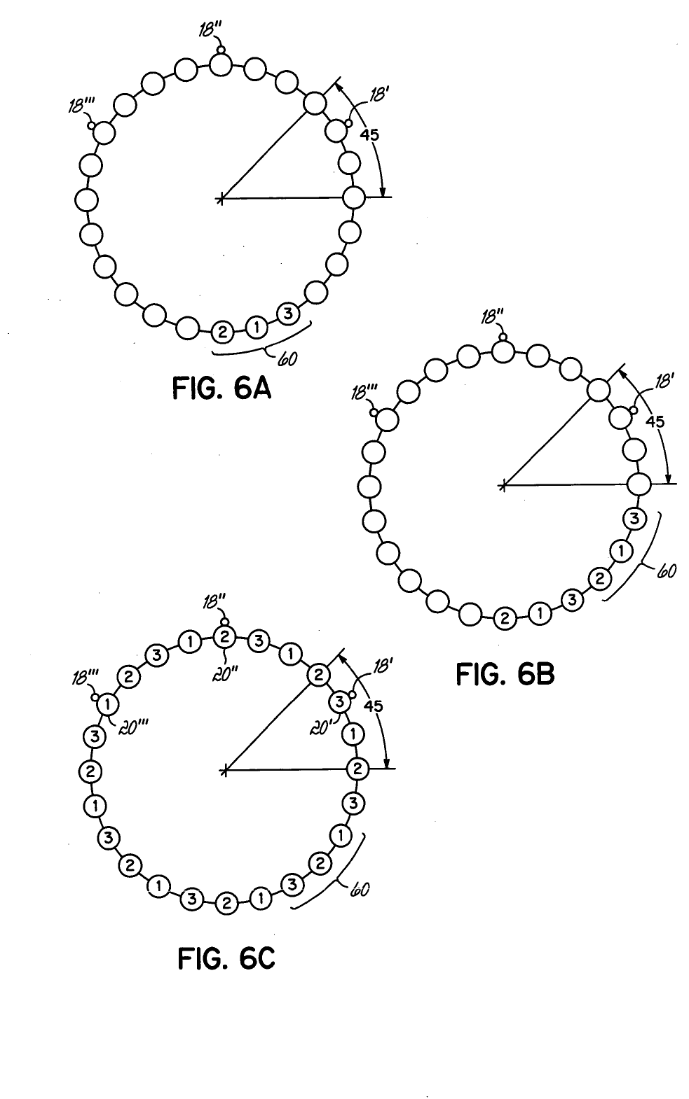

Referring now to FIGS. 6A-6C, the method of operation of the illustrated embodiment of the system 10 of the present invention is described. The labeling process includes a particular sequence of events that occurs at each decorating station 16 as a label is applied. Initially, the articles 20 are located at a first position which is distant to the decorating station 16. In the illustrated embodiment of the present invention shown in the Figures (FIGS. 1 and 2), this first position may be in the article conveyor 14, along the labeling path 26, or outside the article conveyor 14, such as in the area just prior to the turret 22 of the illustrated embodiment. In this first position, the transfer rolls 18 are not in confronting relationship with articles 20. From this first position, the article conveyor 14 moves the article 20 to a second position. In particular, in the illustrated embodiment, the article conveyor 14, being the rotatable turret 22, is rotated by the first drive system 54 to move the article 20 to the second position which is proximal to and in confronting relationship with a transfer roll 18. In one embodiment of the present invention, the article conveyor 14 may register the article 20 in order to make sure that the label will be properly applied to the article 20. For example, as the article 20 is seated in the article holding assembly 44, a detent 50 located on the side of the article 20 may be used by the article holding assembly 44 to position the article 20 in a particular position so that a label may be applied to the article 20 while avoiding having that label overlap with a feature 52, such as the seam, of the article 20. This facilitates a higher quality application of label 12 to article 20. The registering of the article 20 may take place at any point prior to the application of label to article 20. Thus, registering may take place at the first position, the second position, or during transport of the article 20 between the first and second positions.

Once the article conveyor 14, being the turret 22 in the illustrated embodiment, moves the container into the second position in front of a transfer roll 18, the article seat 48, driven by the second drive system 56, rotates the container as the label is applied. Once the article 20 is in the second position, the stopping period of the intermittent motion begins, and the turret 22 of the illustrated embodiment ceases to rotate. Thus, more specifically, the article conveyor 14 moves the article 20 to a second position in front of the decorating station 16. The article 20 is seated in the article seat 48 of the article holding assembly 44, and the nozzle 46 of the article holding assembly 44 may be lowered and attached to the article 20. The article 20 may then be inflated to create pressure on the inside of the article 20 so that the surface of the article 20 will be substantially rigid as the label 12 is applied. The article holding assembly 44, and particularly, the article seat 48 in which the article 20 is seated, is then rotated, thereby cooperatively rotating the article 20. Meanwhile, the web 24 carrying labels 12 is moved into contact with the article 20 by a transfer roll 18 as the transfer roll 18 is moved in a direction toward the article 20. The third drive system 58 facilitates movement of the web 24 at the same velocity as the rotation of the article 20. As the transfer roll 18 is moved toward the article 20, the web 24 carrying labels 12 contacts the outer surface of the article 20. As the label 12 contacts the article 20, the label 12 is applied to the article 20. Thereafter, the nozzle 46 may be removed from contact with the article 20, and the article 20 deflates. The stopping period then ends, and the article conveyor 14 re-enters a moving period and moves the article 20 out of the second position to a third position distant to and out of confronting relationship with the decorating station 16. As with the first position, the third position may be in the article conveyor 14, or outside the article conveyor 14.

While the above sequence was described with respect to one article 20 moving along the labeling path 26, it will be recognized that in the system 10 of the present invention, as depicted in the Figures, more than one article 20 may be decorated at any given time and more than one article 20 may be moved along the labeling path 26 at any given time.

In particular, in the embodiment of the invention illustrated in FIGS. 6A-6C, a plurality of subsets 60 of containers are moved along the labeling path 26 by the article conveyor 14, being the rotatable turret 22 in the illustrated embodiment. As described above, each of the subsets 60 contains at least first and second articles 20′, 20” to be decorated. In the particular embodiment illustrated in FIGS. 6A-6C, each subset 60 includes first, second, and third articles 20′, 20”, 20′″ to be decorated. While in the illustrated embodiment, the number of articles 20 in the subset 60 is equal to the number of decorating heads located on the system 10, this is not necessary in the system 10 of the present invention. However, it is preferable that the number of articles 20 in each subset 60 be equal to the number of operating decorating stations 16 in the system 10. For example, a system 10 may include three decorating stations 16. However, one of those decorating stations 16 may be either out of order or simply not in use in the particular labeling operation, and thus each subset 60 may only include first and second articles 20′, 20” to be decorated.

Describing the illustrated embodiment and referring now to FIG. 6A, a first subset 60 including first, second, and third articles 20′, 20″, 20′″ to be decorated, has entered the article conveyor 14. Referring now to FIG. 6B, a second subset 60, including first, second, and third articles 20′, 20″, 20′″ to be decorated, has moved into the article conveyor 14 and is moved along the labeling path 26 by the article conveyer 14 due to the rotation of the turret 22. The first, second, and third articles 20′, 20″, 20′″ of each of the subsets 60 is labeled with the numbers 1, 2, and 3 in FIGS. 6A-6C. Referring now to the embodiment illustrated in FIG. 6C, multiple subsets 60 have entered and proceeded around the labeling path 26 by the article conveyor 14 such that there are eight subsets 60. It will be recognized by those skilled in the art that more or less subsets 60 may be located along the labeling path 26.

The embodiments illustrated in FIGS. 6A-6C also include first, second, and third transfer rolls 18′, 18″, 18′″, disposed proximal to the article conveyor 14. As the plurality of subsets 60 pass along the labeling path 26, certain articles 20 of each subset 60 reach the second position proximal to one of the transfer rolls 18 of the illustrated embodiment. In particular, in the illustrated embodiment of FIG. 6C, the first article 20′ of each of the plurality of subsets 60 has a second position which is proximal to and in confronting relationship with the third transfer roll 18′″. The second article 20” of each of the plurality of subsets 60 of articles 20 has a second position proximal to and in confronting relationship with the second transfer roll 18″, and the third article 20′″ of each of the plurality of subsets 60 of articles 20 has a second position proximal to and in confronting relationship with the first transfer roll 18′. The 45 angle notation of FIGS. 6A-6C denotes the distance the article conveyor 14 moves during each moving period. This distance is sufficient to move the articles 20 forward such that once an article 20 leaves the second position, two articles 20 bypass a particular transfer roll 18 before another stopping period occurs. Thus, in the illustrated embodiment the first article 20′ of each subset 60 will be decorated at the third transfer roll 18′″, the second article 20″ of each subset 60 will be decorated at the second transfer roll 18″, and the third article 20′″ of each subset 60 will be decorated at the first transfer roll 18′.

When the article conveyor 14 enters the stopping period, a first, second, and third article 20′, 20″, 20′″ will be stopped in the second position in front of third, second, and first decorating stations 16, respectively. At that point, each of the first, second, and third articles 20′, 20″, 20′″ is seated in the article seat 48 of the article holding assembly 44, a nozzle 46 may attach to and inflate each article 20′, 20″, 20′″, and the articles 20′, 20″, 20′″ are rotated against the labels 12 which are drawn across the transfer rolls 18′, 18″, 18′″ to decorate the articles 20′, 20″, 20′″. The nozzle 46 is then removed, and the articles 20′, 20″, 20′″ deflate. At that point, the stopping period ends, and the article conveyor 14 enters a moving period again and moves the articles 20′, 20″, 20′″ forward to the next stopping period. As the articles 20′, 20″, 20′″ are moved to or past the third position, they may be heated in order to enhance the adherence of labels 12 to articles 20′, 20″, 20′″. The rotating turret 22 of the illustrated embodiment thus moves to bring the next first article 20′ into position proximal to by the third transfer roll 18′″, the next second article 20″ into position proximal to the second transfer roll 18″, and the next third article 20′″ into position proximal to the first transfer roll 18′.

While the invention has been disclosed by reference to the details of preferred embodiments of the invention, it is to be understood that the disclosure is intended in an illustrative rather than in a limiting sense, as it is contemplated that modifications will readily occur to those skilled in the art, within the spirit of the invention and the scope of the appended claims.

1. A system for applying labels to articles, the system comprising:
an article conveyor adapted for imparting intermittent motion to articles to be labeled; and
a plurality of decorating stations, each having a transfer roll proximate to and adapted to be in confronting relationship with selected articles being carried by said article conveyor, each of said transfer rolls associated with a web including labels;
wherein each of said articles moving on the article conveyor receives at least one label from one of said decorating stations.

2. The system of claim 1, further comprising a controller operably coupled to the article conveyor and to each of the decorating stations to coordinate intermittent motion of the articles on the article conveyor with the operation of each decorating station, wherein said intermittent motion includes a moving period and a stopping period, and wherein said stopping period substantially coincides with the application of said labels to said articles.

3. The system of claim 1, further including a first drive system for driving said article conveyor.

4. The system of claim 3, wherein said article conveyor includes a rotatable turret operably coupled to the first drive system.

5. The system of claim 1, further including a plurality of rotatable article holding assemblies, each proximate to one of said decorating stations, and adapted to receive the selected article for processing by the associated decorating station.

6. The system of claim 5, wherein each said article holding assembly includes an article seat adapted to be disposed beneath said article when said article is in said article holding assembly, said article seat adapted to receive said article.

7. The system of claim 6, wherein said article holding assembly includes a nozzle adapted to be disposed above said article when said article is in said article holding assembly, said nozzle being in communication with an air source and adapted to contact and confront said article in such manner as to inflate said article with air.

8. The system of claim 5, wherein each article holding assembly further comprises a second drive system for rotating said article holding assembly in a first direction.

9. The system of claim 8, wherein each of said decorating stations further comprises a third drive system for rotating the associated transfer roll and for moving said web, said web causing rotation of said transfer rolls in a second direction, said second direction being opposite to said first direction.

10. The system of claim 2, wherein said stopping period occurs when said article being carried by said article conveyor is proximate to and in confronting relationship with one of said decorating stations.

11. The system of claim 1, wherein said plurality of decorating stations cooperate to apply the labels to said articles at a rate of greater than 150 labels per minute.

12. The system of claim 1, wherein each decorating station further comprises a heat source for enhancing application of said labels to said articles.

13. The system of claim 1, wherein each of said plurality of decorating stations simultaneously applies labels to articles.

14. The system of claim 1, wherein multiple decorating stations each apply one of labels to the same article.

15. A system for applying labels to articles, the system comprising:
an article conveyor adapted for imparting intermittent motion to articles to be labeled;
a plurality of decorating stations, each having a transfer roll proximate to and adapted to be in confronting relationship with selected articles being carried by said article conveyor, each of said transfer rolls associated with a web including labels, wherein each of said articles moving on the article conveyor receives at least one label from one of said decorating stations;
a controller operably coupled to the article conveyor and to each of the decorating stations to coordinate intermittent motion of the articles on the article conveyor with the operation of each decorating station, wherein said intermittent motion includes a moving period and a stopping period, and wherein said stopping period substantially coincides with the application of said labels to said articles;
a first drive system for driving said article conveyor;
a plurality of rotatable article holding assemblies, each proximate to one of said decorating stations, and adapted to receive the selected article for processing by the associated decorating station, wherein each article holding assembly further comprises a second drive system for rotating said article holding assembly in a first direction; and
a third drive system for rotating the associated transfer roll and for moving said web, said web causing rotation of said transfer rolls in a second direction, said second direction being opposite to said first direction.

16. A method for applying labels to articles, the method comprising:
intermittently moving a series of articles to be labeled on an article conveyor along a labeling path proximate at least first and second decorating stations in confronting relationship with articles being carried by said article conveyor, said first and second decorating stations having first and second webs, respectively, each including labels;
stopping said article conveyor such that a first article is in confronting relationship with said first decorating station and a second article is in confronting relationship with said second decorating station; and
applying labels to said first and second articles associated with said first and second decorating stations while said first and second articles are stopped.

17. The method of claim 16, further comprising moving said articles along the labeling path with said article conveyor subsequent to applying said labels such that said first article having been labeled and said second article having been labeled are moved from confronting relationship with said first and second decorating stations, respectively.

18. The method of claim 17, further comprising stopping said article conveyor such that a third article to be labeled is in confronting relationship with said first decorating station and a fourth article to be labeled is in confronting relationship with said second decorating station.

19. The method of claim 16, wherein said applying labels to said first and second articles is performed sequentially

20. The method of claim 16, wherein said applying labels to said first and second articles is performed simultaneously.

21. The method of claim 16 further comprising heating said labels prior to applying said labels to said articles.

22. The method of claim 16 further comprising heating said labels and said articles subsequent to applying said labels to said articles.

23. The method of claim 16, further comprising applying a first label to said first article at said first decorating station, and subsequently applying a second label to said first article at said second decorating station.

24. A method for applying labels to articles, the method comprising:
intermittently moving a series of articles to be labeled on an article conveyor along a labeling path proximate at least first and second decorating stations in confronting relationship with articles being carried by said article conveyor, said first and second decorating stations having first and second webs, respectively, each including labels;
stopping said article conveyor such that a first article is in confronting relationship with said first decorating station and a second article is in confronting relationship with said second decorating station;
applying labels to said first and second articles associated with said first and second decorating stations while said first and second articles are stopped;
moving said articles along the labeling path with said article conveyor subsequent to applying said labels such that said first article having been labeled and said second article having been labeled are moved from confronting relationship with said first and second decorating stations, respectively; and
stopping said article conveyor such that a third article to be labeled is in confronting relationship with said first decorating station and a fourth article to be labeled is in confronting relationship with said second decorating station.
